(19) United States
(12) Patent Application Publication
(10) Pub. No.: US 2020/0291680 A1
(43) Pub. Date: Sep. 17, 2020

(54) METHOD FOR OPERATING COMBINATION LOCK WITH A KEYBOX

(71) Applicant: Yao-Kun Yang, CHANGHUA COUNTY (TW)

(72) Inventor: Yao-Kun Yang, CHANGHUA COUNTY (TW)

(21) Appl. No.: 16/891,089

(22) Filed: Jun. 3, 2020

Related U.S. Application Data
(63) Continuation-in-part of application No. 16/100,208, filed on Aug. 10, 2018.

(51) Int. Cl. E05B 37/00; E05B 37/02

(52) U.S. Cl. CPC E05B 37/0044; E05B 67/14; E05B 37/0037; E05B 37/025

(57) ABSTRACT

A method for operating a combination lock including a body and a shackle. A keybox is located in the body and includes a cover. The body includes a first control panel, a second control panel and a switch button. The method includes a step of setting a first combination to the first control panel, a second combination to the second control panel. A step of switching the switch button to the first position so that the shackle is operated and the cover is opened relative to the keybox by inputting the first combination or the second combination from the first control panel. When the switch button is switched to the second position, the shackle is operated and the cover is opened relative to the keybox by inputting the first combination or the second combination from the second control panel.

This application is a Continuation-In-Part patent application of applicant's former patent application Ser. No. 16/100,208, and relates to a method for operating a combination lock with a keybox by multiple ways.

### BACKGROUND OF THE INVENTION

### 1. Fields of the Invention

### 2. Descriptions of Related Art

The conventional combination lock generally includes 3 to 4 digital wheels and each wheel has 0 to 9 digits, the correct combination requires the pre-set digit shown in each of the digit wheels. Nevertheless, the shortcomings of the conventional combination locks is that the combination of the digits can be decoded, or the users forget the combination. Besides, a surf lock is developed and provides a keybox that is used to safely keep keys in the keybox. The keybox is also controlled by a correct combination.

U.S. Pat. No. 9,540,845 and US Pub. No. 2017/0234038 respectively disclose a locking mechanism with a room for keeping keys therein. It is noted that only one combination unit or control unit is available for pivoting the cover or the door between a closed position and an opened position. That is to say, the cover or the door requires one set of combination, and/or the lock requires another set of combination. Applicant believes the disclosed method for operating the lock mechanism still has safety limitation and needs to be improved.

The present invention is intended to provide a method for operating a combination lock with a keybox, and the method is designed to eliminate the drawbacks mentioned above.

### SUMMARY OF THE INVENTION

The present invention relates to a method for operating a combination lock. The combination lock includes a body and a shackle. The shackle includes a first end pivotably and movably connected to the body, and a second end of the shackle removably inserted into the body. A keybox is located in the body and includes a cover. A combination device is connected to the body and includes a first control panel, a second control panel and a switch button. The first control panel includes multiple digit wheels rotatably connected thereto. The second control panel includes multiple number buttons and multiple function buttons. The number buttons includes 0 to 9 respectively marked thereon. The first control panel and the second control panel control the shackle and the cover. The switch button is switched to a first position to activate the first control panel. The switch button is switched to a second position to activate the second control panel. The method comprises:

a step of setting combinations: a first combination being set to the first control panel, a second combination being set to the second control panel, the second combination being a spare combination; and

a step of switching the switch button: when switching the switch button to the first position, the shackle is operated and the cover is opened relative to the keybox by inputting the first combination or the second combination from the first control panel, when switching the switch button to the second position, the shackle is operated and the cover is opened relative to the keybox by inputting the first combination or the second combination from the second control panel.

The present invention also provides another method for operating the combination lock, and comprises:

a step of setting combination: a first combination and a second combination being respectively set to the first control panel, and

a step of switching the switch button: when switching the switch button to the first position, the shackle is operated by inputting the first combination from the first control panel, when switching the switch button to the second position, the cover is opened relative to the keybox by inputting the second combination from the first control panel.

The present invention further provides yet another method for operating the combination lock, and comprises:

a step of connection: connecting the second control panel to an application (APP) of a smart phone, and

a step of setting a combination: setting a combination to the second control panel by operating the application from the smart phone, the shackle being operated and/or the cover being opened relative to the keybox by inputting the combination to the second control panel.

Preferably, the shackle is operated and/or the cover is opened relative to the keybox by inputting the combination from the smart phone.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the front view of the combination lock of the present invention, wherein the combination lock is in locked status;

FIG. 2 shows the front view of the combination lock of the present invention, wherein the combination lock is in unlocked status;

FIG. 3 shows that the cover is opened relative to the keybox of the combination lock of the present invention;

FIG. 4 shows the first control way of the combination lock of the present invention;

FIG. 5 shows the second control way of the combination lock of the present invention;

FIG. 6 shows the third control way of the combination lock of the present invention;

FIG. 7 shows the fourth control way of the combination lock of the present invention;

FIG. 8 shows the fifth control way of the combination lock of the present invention;

FIG. 9 shows the sixth control way of the combination lock of the present invention, and

FIG. 10 shows the sixth control way of the combination lock of the present invention.

### DETAILED DESCRIPTION OF THE PREFERRED EMBODIMENT

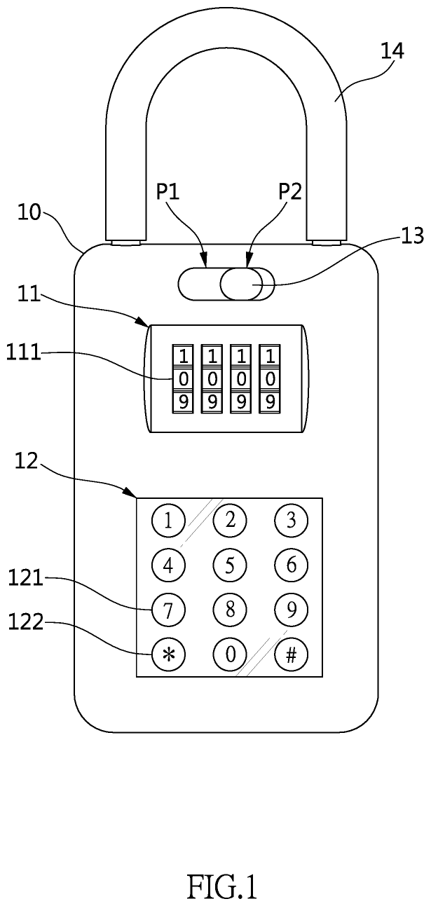

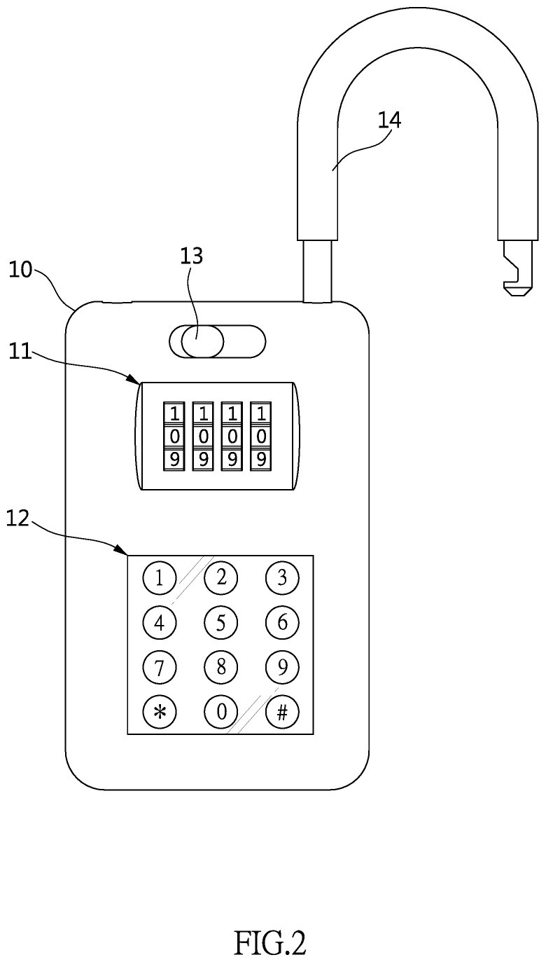

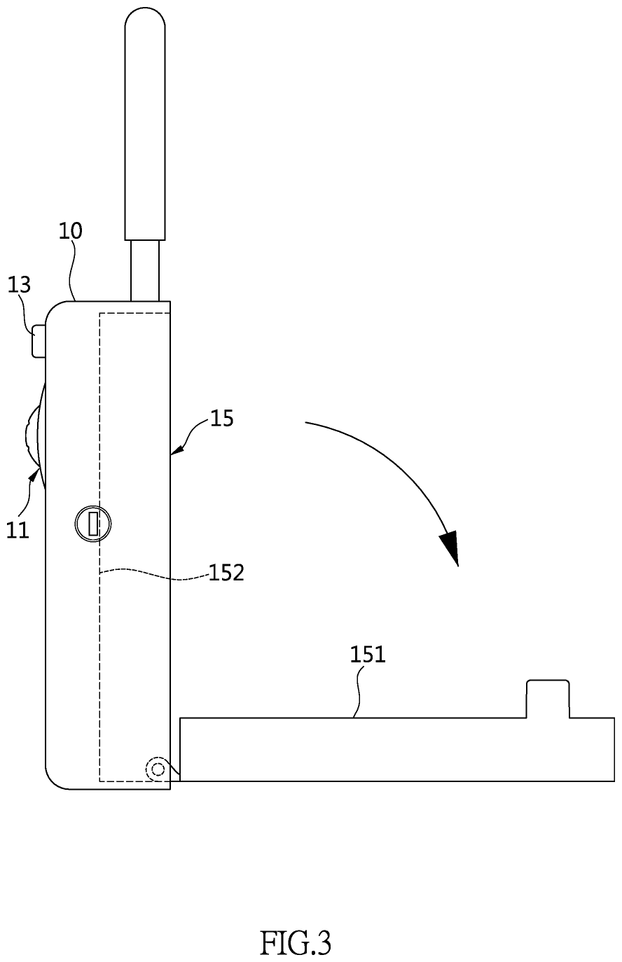

Referring to FIGS. 1 to 3, the combination lock of the present invention comprises a body 10 and a shackle 14, wherein the shackle 14 has the first end pivotably and movably connected to the body 10, and the second end of the shackle 14 is removably inserted into the body 10. A keybox 15 is located in the body 10 and includes a room 152 for receiving keys or the like therein. A cover 151 is pivotably connected to the body 10 and is able to close the room 152 for safety reason by any known methods.

The combination lock has a combination device connected to the body 10 and includes a first control panel 11, a second control panel 12 and a switch button 13. The first control panel 11 has multiple digit wheels 111 rotatably connected thereto. The second control panel 12 has multiple number buttons 121 and multiple function buttons 122. The number buttons 121 has 0 to 9 respectively marked thereon. The first control panel 11 and the second control panel 12 control the shackle 14 and the cover 151. The switch button 13 can be switched to a first position P1 to activate the first control panel 11, and the switch button 13 can be switched to a second position P2 to activate the second control panel 12.

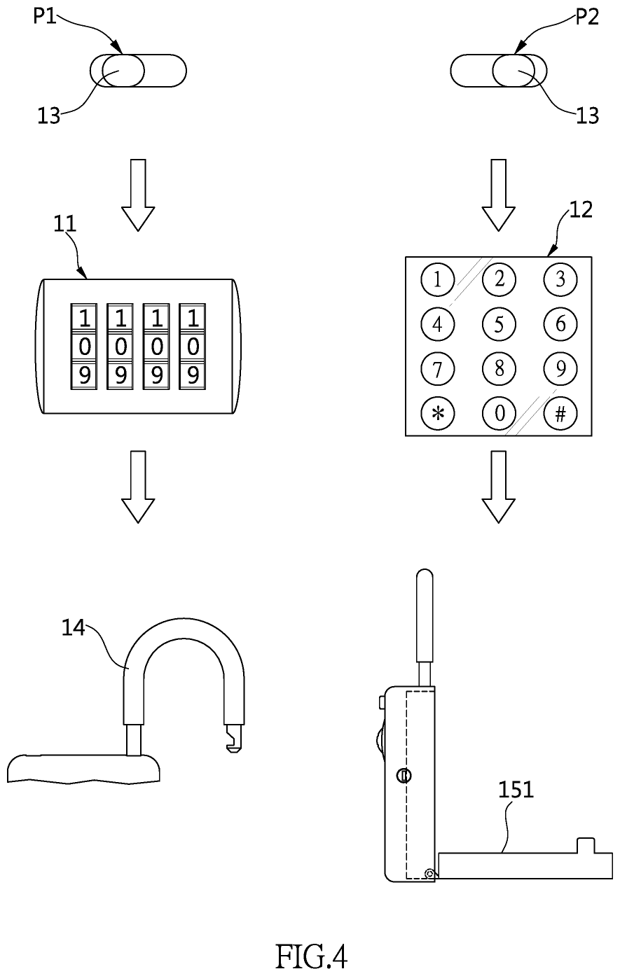

As shown in FIG. 4, the first method for operating the combination lock comprises:

a step of setting combinations: a first combination being set to the first control panel 11, a second combination being set to the second control panel 12, the second combination being a spare combination; and

a step of switching the switch button 13: when switching the switch button 13 to the first position P1, the shackle 14 is operated and the cover 151 is opened relative to the keybox 15 by inputting the first combination or the second combination from the first control panel 11, when switching the switch button 13 to the second position P2, the shackle 14 is operated and the cover 151 is opened relative to the keybox 15 by inputting the first combination or the second combination from the second control panel 12.

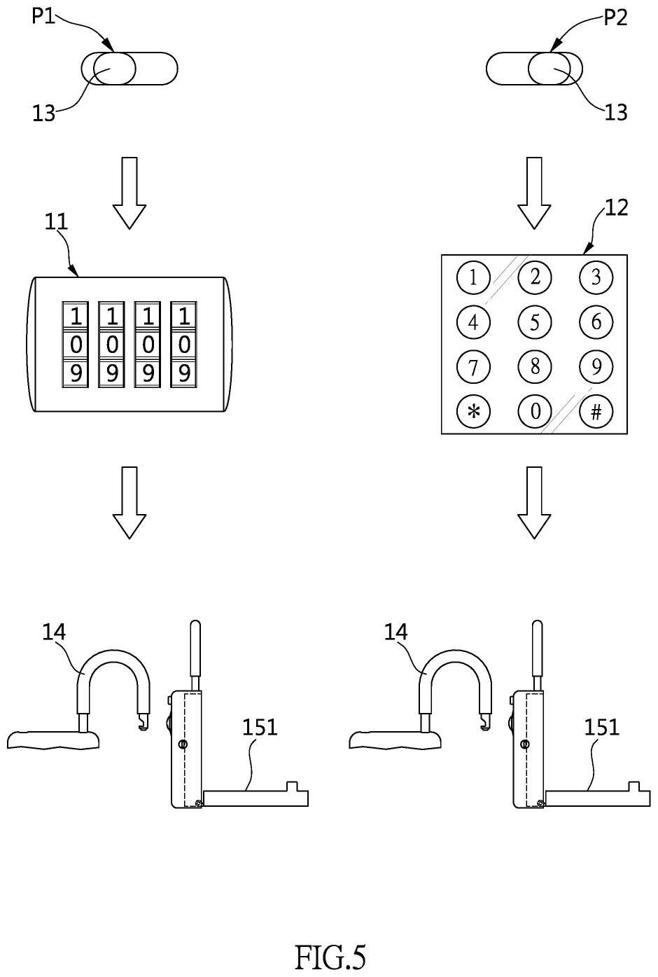

The second method is that the first control panels 11 includes a first combination, and the second control panel 12 includes a second combination. The second combination is a spare combination in case the first combination is forgotten. As shown in FIG. 5, when the switch button 13 is switched to the first position P1, the shackle 14 is operated and the cover 151 is opened relative to the keybox 15 by inputting the first combination from the first control panel 11. If the first control panel 11 is out of order or the first combination is forgotten, the switch button 13 is switched to the second position P2, the shackle 14 is operated and the cover 151 is opened relative to the keybox 15 by inputting the second combination from the second control panel 12. The first combination can be used as a primary combination and the second combination can be used as a secondary combination.

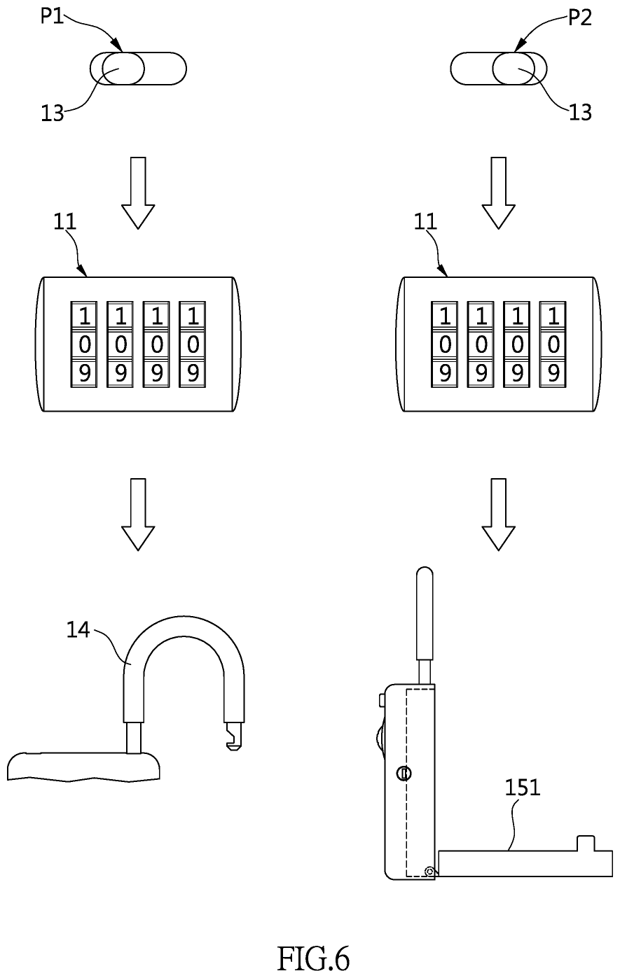

As shown in FIG. 6, the third method for operating the combination lock as described above comprises:

a step of setting combination: a first combination and a second combination being respectively set to the first control panel 11, and

a step of switching the switch button 13: when switching the switch button 13 to the first position P1, the shackle is operated by inputting the first combination from the first control panel 11, when switching the switch button 13 to the second position P2, the cover 151 is opened relative to the keybox 15 by inputting the second combination from the first control panel 11.

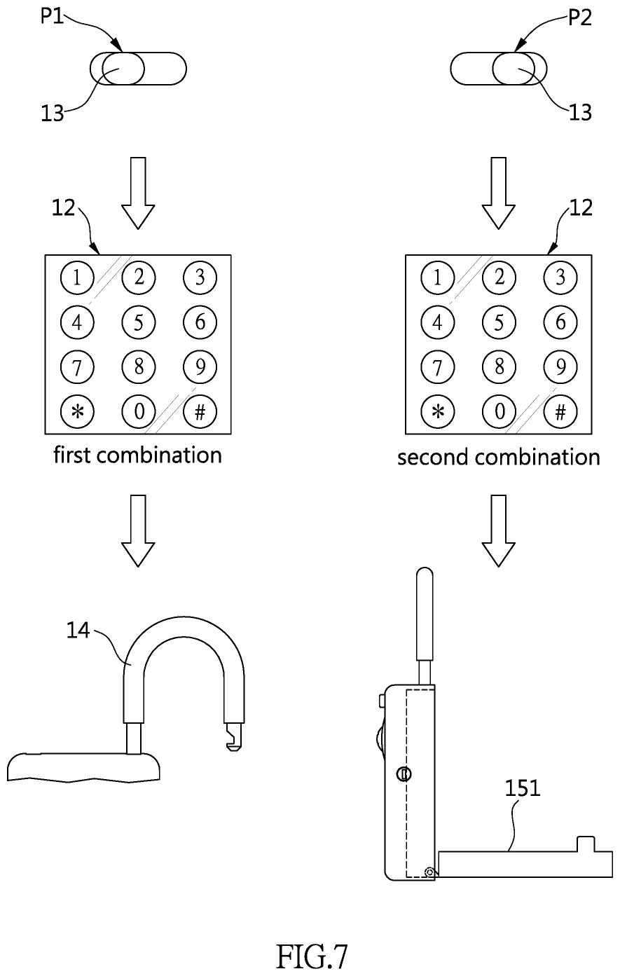

As shown in FIG. 7 which shows the fourth method, wherein the first control panel 11 in the third method can be replaced by the second control panel 12. That is to say, a first combination and a second combination are respectively set to the second control panel 12. When switching the switch button 13 to the first position P1, the shackle 14 is operated by inputting the first combination from the second control panel 12. When switching the switch button 13 to the second position P2, the cover 151 is opened relative to the keybox 15 by inputting the second combination from the second control panel 12.

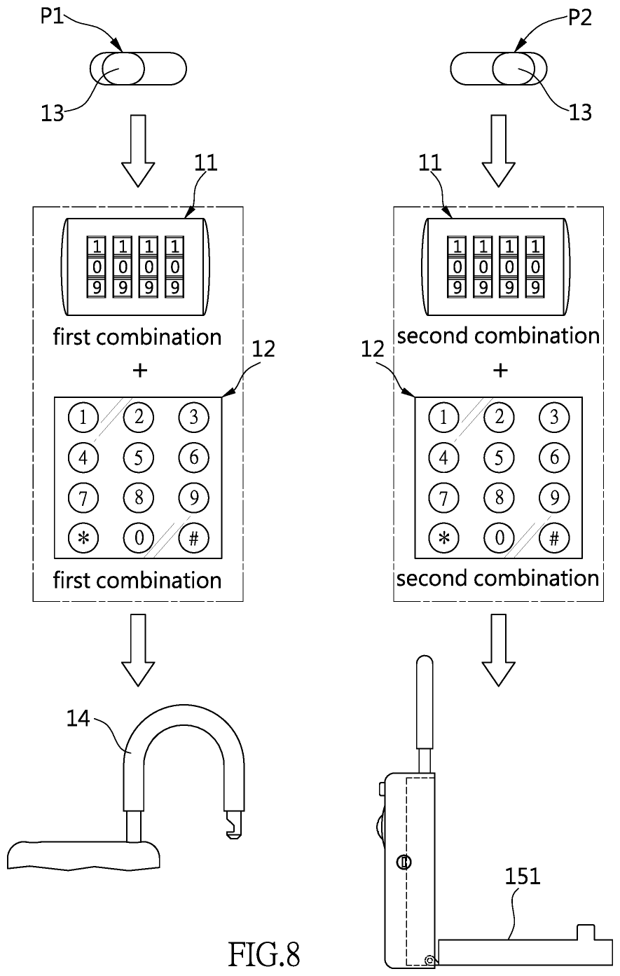

FIG. 8 shows the fifth method, wherein a first combination is set to the first control panel 11, and a second combination is set to the second control panel 12. A first combined combination is defined by a combination of the first combination and the second combination. Similarly, a third combination is further set to the first control panel 11, and a fourth combination is further set to the second control panel 12. A second combined combination is defined by a combination of the third combination and the fourth combination.

When the switch button 13 is switched to the first position P1, the shackle 14 is operated by inputting the first combined combination from the first control panel 11 and the second control panel 12 respectively. When the switch button 13 is switched to the second position P2, the cover 151 is opened relative to the keybox 15 by inputting the second combined combination from the first control panel 11 and the second control panel 12 respectively. The first combined combination may be set to control the cover 151, and the second combined combination may be set to control the shackle 14.

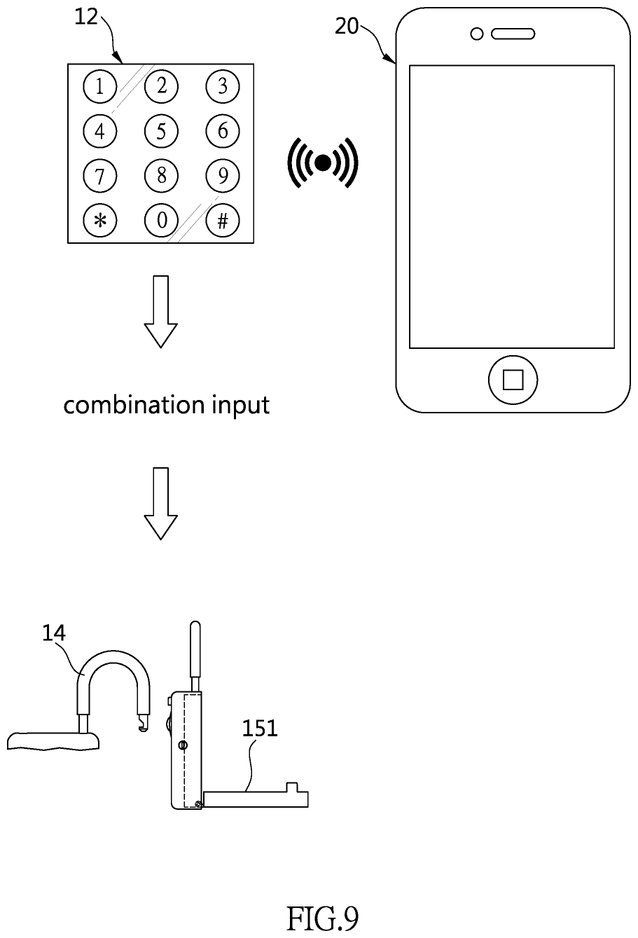

As shown in FIG. 9, the sixth method for operating the combination lock as described above comprises:

a step of connection: connecting the second control panel 12 to an application (APP) of a smart phone, and

a step of setting a combination: setting a combination to the second control panel 12 by operating the application from the smart phone, the shackle 14 being operated and/or the cover 151 being opened relative to the keybox 15 by inputting the combination to the second control panel 12.

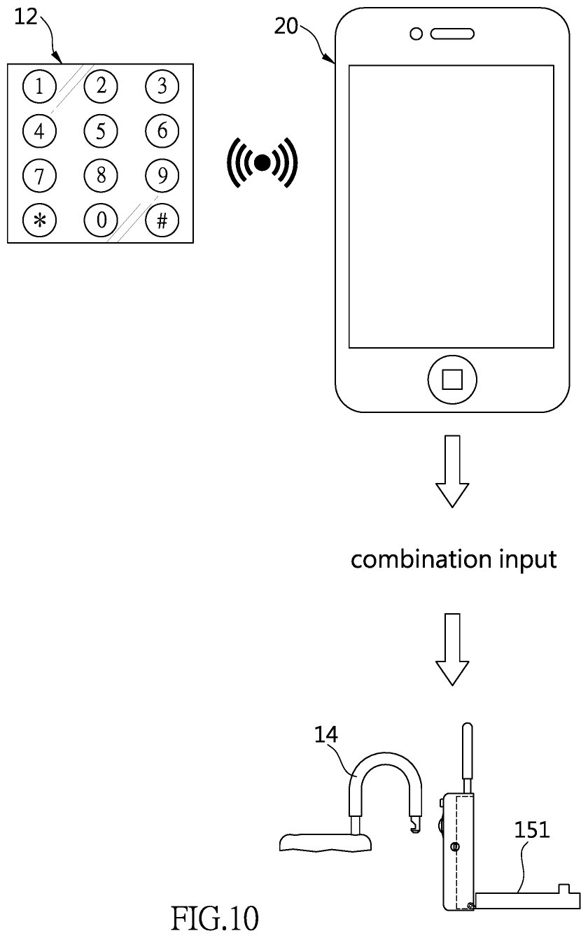

As shown in FIG. 10, the shackle 14 can also be operated and/or the cover 151 is opened relative to the keybox 15 by inputting the combination from the smart phone.

While we have shown and described the embodiment in accordance with the present invention, it should be clear to those skilled in the art that further embodiments may be made without departing from the scope of the present invention.

What is claimed is:

1. A method for operating a combination lock which includes a body and a shackle, the shackle having a first end pivotably and movably connected to the body, a second end of the shackle removably inserted into the body, a keybox located in the body and having a cover, a combination device connected to the body and having a first control panel, a second control panel and a switch button, the first control panel having multiple digit wheels rotatably connected thereto, the second control panel having multiple number buttons and multiple function buttons, the number buttons having 0 to 9 respectively marked thereon, the first control panel and the second control panel controlling the shackle and the cover, the switch button being switched to a first position to activate the first control panel, the switch button being switched to a second position to activate the second control panel, the method comprising:
a step of setting combinations: a first combination being set to the first control panel, a second combination being set to the second control panel, the second combination being a spare combination; and
a step of switching the switch button: when switching the switch button to the first position, the shackle is operated and the cover is opened relative to the keybox by inputting the first combination or the second combination from the first control panel, when switching the switch button to the second position, the shackle is operated and the cover is opened relative to the keybox by inputting the first combination or the second combination from the second control panel.

2. A method for operating a combination lock which includes a body and a shackle, the shackle having a first end pivotably and movably connected to the body, a second end of the shackle removably inserted into the body, a keybox located in the body and having a cover, a combination device connected to the body and having a first control panel, a second control panel and a switch button, the first control panel having multiple digit wheels rotatably connected thereto, the second control panel having multiple number buttons and multiple function buttons, the number buttons having 0 to 9 respectively marked thereon, the first control panel and the second control panel controlling the shackle and the cover, the switch button being switched to a first position to activate the first control panel, the switch button being switched to a second position to activate the second control panel, the method comprising:
a step of setting combination: a first combination and a second combination being respectively set to the first control panel, and
a step of switching the switch button: when switching the switch button to the first position, the shackle is operated by inputting the first combination from the first control panel, when switching the switch button to the second position, the cover is opened relative to the keybox by inputting the second combination from the first control panel.

3. A method for operating a combination lock which includes a body and a shackle, the shackle having a first end pivotably and movably connected to the body, a second end of the shackle removably inserted into the body, a keybox located in the body and having a cover, a combination device connected to the body and having a first control panel, a second control panel and a switch button, the first control panel having multiple digit wheels rotatably connected thereto, the second control panel having multiple number buttons and multiple function buttons, the number buttons having 0 to 9 respectively marked thereon, the first control panel and the second control panel controlling the shackle and the cover, the switch button being switched to a first position to activate the first control panel, the switch button being switched to a second position to activate the second control panel, the method comprising:
a step of connection: connecting the second control panel to an application (APP) of a smart phone, and
a step of setting a combination: setting a combination to the second control panel by operating the application from the smart phone, the shackle being operated and/or the cover being opened relative to the keybox by inputting the combination to the second control panel.

4. The method as claimed in claim 3, wherein the shackle is operated and/or the cover is opened relative to the keybox by inputting the combination from the smart phone.
